(19) United States
(12) Patent Application Publication
(10) Pub. No.: US 2015/0302571 A1
(43) Pub. Date: Oct. 22, 2015

(54) RECOGNITION-BASED AUTHENTICATION, SYSTEMS AND METHODS

(71) Applicant: NantMobile, LLC, Culver City, CA (US)

(72) Inventor: James Lambert, Culver City, CA (US)

(21) Appl. No.: 14/568,015

(22) Filed: Dec. 11, 2014

Related U.S. Application Data
(60) Provisional application No. 61/914,889, filed on Dec. 11, 2013.

(51) Int. Cl. G06T 7/00; H04L 29/06; G06F 17/30

(52) U.S. Cl. CPC G06T 7/003; G06F 17/30259; H04L 63/08

(57) ABSTRACT

An authentication engine authenticates a user to access a service via a computing device by executing an object recognition algorithm on an image received from a different computing device. Specifically, the authentication engine presents an image token on a first computing device after receiving a request. The authentication engine then instructs the user to use a second computing device to capture a digital photo of the image token. Upon receiving the photo from the second device, the authentication engine executes an object recognition algorithm on the photo to derive a set of image descriptors. The authentication engine then generates an image difference by comparing the set of descriptors of the photo against the set of descriptors of the image token. Based on the image difference, the authentication engine authenticates the user to use a service via the first computing device.

This application claims priority to U.S. Application 61/914,889, filed Dec. 11, 2013. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is directed to authentication technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Authentication is an important process to enable users to securely use an electronic service provided through a computing device (e.g., an online banking service, an e-mail service, etc.). Conventional authentication techniques usually require a user, who would like to be authenticated to use a service, to provide a token (e.g., a password, a biometric sample, etc.) that is predetermined, and the service authenticates the user based on the token. However, there are many drawbacks with these techniques. For example, a secure password is usually very long and difficult to remember. In addition, the password, no matter how secure it is, can be lost and/or stolen by hackers (e.g., by key-logging), especially on shared computers at work, libraries, cafes, etc. Biometric authentication is generally more secure than password, but requires additional equipment for scanning the biometric sample.

Efforts have been made to improve on authentication techniques to make it more secure and user-friendly. For example, U.S. Patent Publication 2013/111208 by Sabin et al. entitled “Techniques for Authentication via a Mobile Device,” filed Oct. 31, 2011 (Sabin) discloses an authentication technique in which a coded session identifier (e.g., a QR code) is displayed on the computing device by a service provider. The user can capture the session identifier using a mobile device (e.g., a mobile phone). The mobile device then encrypts the session identifier with its private key, and sends the signed and encrypted session identifier to the identity service to authenticate the user. However, there are a few drawbacks in this implementation. First, the identity service requires an identical match in order to authenticate the user, meaning, failure to accurately capture the QR code (e.g., due to lighting condition, movement, etc.) would prevent the user from successfully log on to the service. Second, the coded session identifier cannot be deciphered by naked eyes, which allows malicious hackers to phish sensitive information of the user by masquerading as a legitimate trustworthy service provider.

U.S. Pat. No. 8,261,089 issued to Cobos et al. entitled “Method an System for Authenticating a User by Means of a Mobile Device,” filed Sep. 17, 2009 (Cobos) discloses an authentication method similar to the one from Sabin. The method in Cobos presents a coded challenge (e.g., a bar coded challenge) to a user. The challenge includes a request for a personal secret of the user and a URL. Upon capturing an image of the coded challenge, the mobile device retrieves the personal secret of the user and sends the secret, along with the challenge and userID to the URL embedded in the coded challenge. Similar to the Sabin's method, the authentication technique disclosed in Cobos requires that the user accurately capture the coded challenge. In addition, this technique is also prone to phishing where a malicious hacker provides an interface that masquerades as a trustworthy service provider. The malicious hacker can generate its own coded challenge and request the user to send the personal secret the hacker's own URL.

Other efforts have been made toward improving online authentication, including:
U.S. Pat. No. 8,701,166 issued to Courtney et al. entitled “Secure Authentication,” filed Dec. 8, 2011;
U.S. Patent Publication 2013/0219479 by DeSoto et al. entitled “Login Using QR Code,” filed Feb. 15, 2013; and
U.S. Patent Publication 2014/0197232 by Birkler et al. entitled “System and Method for Establishing a Communication Session,” filed Mar. 30, 2012;

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved authentication techniques.

### SUMMARY OF THE INVENTION

The inventive subject matter provides apparatus, systems and methods in which an authentication engine authenticates a user to access a service via a computing by executing an object recognition algorithm on a set of images received from a different computing device. Specifically, the contemplated authentication technique involves presenting an image token on a first computing device. The image token can be pre-selected by the user during a registration process or can be randomly chosen by the authentication engine. The image token is stored in a storage device before presenting to the user via the first computing device. In addition, the authentication engine of some embodiments is programmed to execute an object algorithm on the image token to derive a set of image descriptors and to store the set of image descriptors in the storage. The set of image descriptors will be used to authenticate the user during the authentication process.

In some embodiments, the first computing device is the device via which the user would like to access a service. The authentication engine is programmed to then instruct the user to use a second computing device to capture a photo of the image token being presented on a display of the first computing device to generate authentication image data, and send the authentication image data to the authentication engine. In some embodiments, the second computing device is pre-designated by the user to perform this authentication function. The user can designate the second computing device as the authentication device by providing an identifier of the second computing device to the authentication engine during the registration process.

Upon receiving the image data, the authentication engine of some embodiments is programmed to execute an object recognition algorithm on the authentication image data to derive another set of image descriptors. The authentication engine then generates an image difference by comparing the set of descriptors of the authentication image data against the set of descriptors of the image token. Based on the image difference and the identifier of the second computing device, the authentication engine authenticates the user to use a service via the first computing device. In some embodiments, the authentication engine is programmed to authenticate the user even if the image difference is not null (i.e., the descriptor sets of the image token and the descriptor sets of the photo are not identical). In these embodiments, the authentication engine is programmed to authenticate the user when the image difference is below a pre-determined threshold and to refuse authentication of the user when the image difference exceeds the predetermined threshold.

In some of the embodiments, the authentication engine initiates a handshake session between the first and second computing devices during the authentication process. In some of these embodiments, the handshake session has at least a duration attribute and/or an access level attribute.

In some embodiments, the first and second computing devices are both communicatively coupled to the authentication engine, but the first and second computing devices are not communicatively coupled with each other. After the request to access the service is received, the authentication engine is programmed to abort the handshake session (and abort the authentication process) when no image data is received from the second computing device within a predetermined duration of time.

The authentication engine of some embodiments is programmed to also provide a user interface that enables a user to select and designate an image as the image token for authentication purpose associated with a user account.

In addition to using this authentication technique to authenticate a user to use a service on a computing device, it is contemplated that the same authentication technique can be used as a handshake sequence to establish a communication session (or channel) between two computing devices.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a schematic of an authentication ecosystem of some embodiments.

FIG. 2 illustrates a process of authenticating a user based on images in detail.

FIG. 3 illustrates a machine-to-machine initial protocol handshake based on image authentication.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

One should appreciate that the disclosed authentication system provides numerous advantageous technical effects. The system enables computing devices to exchange digital tokens in the form of highly complex digital image descriptors derived from digital image data. The digital tokens are exchanged over a network as part of an authentication handshake function. If the computing device determines that the image descriptors satisfy authentication criteria, then the devices are considered authenticated. Thus, multiple computing devices are able to establish trusted communication channels among each other.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used in the description herein and throughout the claims that follow, when a system, engine, or a module is described as configured to perform a set of functions, the meaning of “configured to” or “programmed to” is defined as one or more processors being programmed by a set of software instructions to perform the set of functions.

The inventive subject matter provides apparatus, systems and methods in which an authentication engine authenticates a user to access a service (e.g., an online service such as an online banking service or an online social media service, a communication session between devices, a healthcare network, a gaming environment, etc.) via a computing device (e.g., a personal computer, a tablet, etc.) by executing an implementation of an object recognition algorithm on a set of images received from a different computing device (e.g., a mobile device with a camera). Specifically, the contemplated authentication technique involves presenting an image token on a first computing device (e.g., a personal computer that is being shared among multiple users) after receiving a request from the first computing device. The request can be a request made by a user of the first computing device to access a service via the first computing device or a request to establish a communication session with a second computing device. The receiving of the request marks the beginning of the authentication process (or handshake session).

The image token can be pre-selected by the user during a registration process or can be randomly chosen by the authentication engine. The image token is stored in a memory storage device (e.g., an image token database, RAM, HDD, SSD, file server, etc.) before presenting to the user via the first computing device. In addition, the authentication engine of some embodiments is programmed to execute an implementation of the object recognition algorithm on the image token to derive a set of image descriptors and to store the set of image descriptors in the storage. The set of image descriptors will be used to authenticate the user during the authentication process.

In some embodiments, the first computing device is the device via which the user would like to access a service (e.g., an online banking service, a social media service, a gaming service, a communication service, etc.). The authentication engine is programmed to then instruct the user to use a second computing device (e.g., a mobile phone, a camera, etc.) to capture a photo of the image token being presented on a display of the first computing device to generate authentication image data, and send the authentication image data to the authentication engine. In some embodiments, the second computing device is pre-designated by the user to perform this authentication function. The user can designate the second computing device as the authentication device by providing an identifier (e.g., serial number, a key, a MAC address, GUID, SIM card number, etc.) of the second computing device to the authentication engine during the registration process.

Upon receiving the image data, the authentication engine of some embodiments is programmed to execute an implementation of the object recognition algorithm on the authentication image data to derive another set of image descriptors. The authentication engine then generates an image difference by comparing the set of descriptors of the authentication image data against the set of descriptors of the image token. Based on the image difference and the identifier of the second computing device, the authentication engine authenticates the user to use a service via the first computing device. In some embodiments, the authentication engine is programmed to authenticate the user even if the image difference is not null (i.e., the descriptor sets of the image token and the descriptor sets of the photo are not identical). In these embodiments, the authentication engine is programmed to authenticate the user when the image difference is below a pre-determined threshold and to refuse authentication of the user when the image difference exceeds the predetermined threshold.

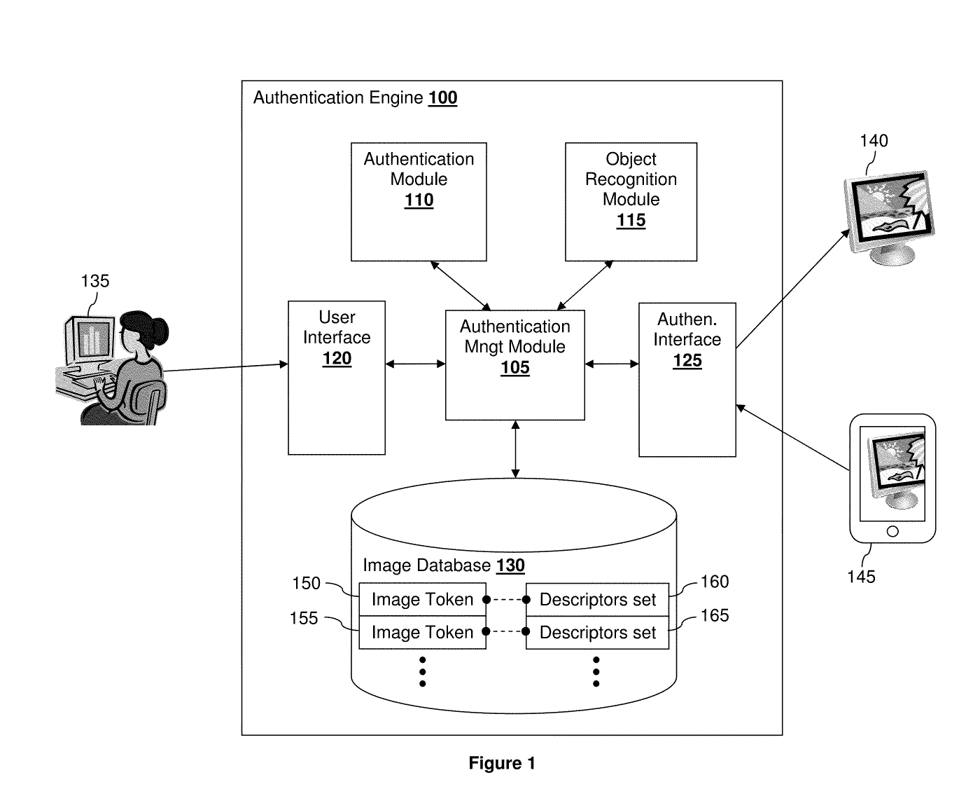

FIG. 1 illustrates an example environment in which an authentication engine 100 of some embodiments can operate. The authentication engine 100 includes an authentication management module 105, an authentication module 110, an object recognition module 115, a user interface 120, and an authentication interface 125. In some embodiments, the authentication management module 105, the authentication module 110, the object recognition module 115, the user interface 120, and the authentication interface 125 can be implemented as software modules that when executed by one or more processing unit (e.g., a processor, a processing core, etc.) perform functions for the authentication engine and fulfill the roles or responsibilities described herein. The authentication engine 100 includes, or communicatively couples with, an image database 130. In some embodiments, the image database 130 includes one or more computing devices that comprise a non-transitory electronic storage (e.g., RAM, a hard drive, flash drive, SAN, NAS, RAID, etc.).

As shown, the image database 130 is programmed to store image tokens (e.g., image tokens 150 and 155) or their corresponding descriptors sets (e.g., descriptors sets 160 and 165). Each image token 150 or 155 is associated with a user account (e.g., the user's online bank account, the user's social media account, the user's gaming service account, etc.). The image token can be selected by a user when the user registers with the authentication services provided by the authentication engine 100 via the user interface 135. For example, through the user interface 135, the user can select an image, from a set of images presented by the authentication engine 100 or from images that the user has on his/her personal computer, as the image token for each of the user's online account. When the user requests access to an online account subsequently, the authentication engine 100 is programmed to present the image token that is associated with that online account (i.e., the image that the user chose as the image token for that online account during the registration process). The advantage of presenting an image token that is pre-selected by the user upon the access request is that the user can also authenticate that the online website is a trustworthy site for providing the requested service, and not a malicious site with intent to phish information of the user, by recognizing the pre-selected image presented on the requesting website.

Alternatively, the user can ask the authentication engine to randomly select an image for the user's online account. Once an image token is selected for a user's online account, the authentication management module 105 is programmed to store the image token and information about the associated user's online account (e.g., URL, user name, etc.) in the image database 130.

In some embodiments, the authentication management module 105 is programmed to request the object recognition module 115 to derive a set of descriptors for each image token that is stored in the image database 130. In some of these embodiments, the object recognition module 115 executes (via a set of processing units) an implementation of an object recognition algorithm on the image token to derive the set of descriptors. The object recognition algorithm can be SIFT, FREAK, DAISY, FAST, or other image processing algorithms that yield descriptor or other quantified feature sets from image data.

The term “descriptor” is used euphemistically to mean a data structure stored in memory where the values in the data structure are derived by executing one or more algorithms (e.g., object recognition algorithm) on a digital representation of an object or scene. Descriptors might represent local or global features in the digital representation (e.g., edges, corners, etc.). Descriptors could also represent specific measures associated with patches of the image (e.g., SIFT descriptors, Histogram of Gradients, etc.). One can use an image recognition algorithm such as scale-invariant feature transform (SIFT; see U.S. Pat. No. 6,711,293 titled “Method and apparatus for identifying scale invariant features in an image and use of same for locating an object in an image” filed Mar. 6, 2000) to detect and describe local features (as descriptors) in images. A typical SIFT descriptor can be a 128-byte vector that represents a 128-bin histogram of gradient orientations. A global descriptor could comprise a histogram with thousands of bins. Multiple descriptors can be derived from a single image. As such, each distinct image is associated with a set of descriptors that uniquely defines the different features of the object. In some embodiments, the authentication engine 100 can recognize objects that are represented in a digital representation (e.g., an image) based on the descriptors derived from the digital representation and the known associations between the descriptors and the objects.

After deriving the set of descriptors for an image token, the authentication management module 105 is programmed to store the set of descriptors and link the set of descriptors to the corresponding image token. In this example, the authentication engine 100 has derived descriptors set 160 for image token 150, and derived descriptors set 165 for image token 155. The authentication engine 100 stores the image tokens and associated descriptors sets in the image database 130.

In addition to the image tokens, the authentication engine 100 is also programmed to prompt the user to provide an identifier of a device (e.g., a mobile phone, a camera, etc.) such as mobile phone 145 that the user would use for authentication when the user wants to access a service via a different computing device. The identifier can be a MAC address, phone number, SIM card numbers, or any other identifier that can uniquely identify the authenticating device. The authentication engine 100 is programmed to store the identifier of the authenticating device 145 and its association with the image token and descriptor set in the database 130.

As shown, the authentication engine 100 is communicatively coupled with a computing device (e.g., a personal computer 140) over a network (e.g., the Internet, a local area network, WiFi, etc.). The computing device can be used by a user to access a service (e.g., an online service). Upon receiving a request to access a service via the computing device 140 from the user (e.g., when the user is trying to log on to the service by providing a user name, etc.), the authentication management module 105 is programmed to present an image token (e.g., image token 150) on the personal computer 140 for authenticating the user. As mentioned above, presenting the image token at this stage of the authentication process also serves the purpose of authenticating the personal computer 140 (and/or the service that the user is requesting access), as the user can recognize that the image token is one that was selected for this particular online account during the registration process. This approach is considered advantageous because it provides the user confidence in the authentication service.

The authentication engine 100 is also programmed to instruct the user (e.g., by presenting a set of instructions to accompany the image token 150 on the personal computer 140) to use a pre-designated authenticating device 145 to capture a photo of the image token 150 being presented on the personal computer 140 and to send the captured photo to the authentication engine 100. The user can then use the authenticating device (e.g., the mobile phone 145) to capture an image of the image token 150 being presented on the computing device 140, and send the captured photo to the authentication engine 100 via the smart phone 145.

In some embodiments, the authentication engine is programmed to instruct the user to send the photo of the image token 150 within a predetermined period of time (e.g., 1 minute, 5 minutes, etc.). In some of these embodiments, the authentication engine is programmed to abort the authentication process (the handshake session) when no image data is received from the second computing device within a predetermined duration of time.

Upon receiving the captured photo from the authenticating device 145 via the authentication interface 125 over a network (e.g., the Internet, a local area network, WiFi, etc.), the authentication management module 105 instructs the object recognition module 115 to derive a set of image descriptors based on the captured photo. Similar to the process being used on the image token, the object recognition module 115 of some embodiments is programmed to execute an implementation of the object recognition algorithm (e.g., SIFT, FREAK, DAISY, FAST, etc.) on the captured photo to derive the set of image descriptors.

The authentication management module 105 then sends the set of image descriptors derived from the image token 150 and the set of image descriptors derived from the photo captured by the smart phone 145 to the authentication module 110 for authenticating the user. In some embodiments, the authentication module 110 generates an image difference between the image token 150 and the captured image by comparing the set of image descriptors derived from the image token 150 and the set of image descriptors derived from the photo captured by the smart phone 145. Based on the image difference generated by the authentication module 110 and the identity of the authentication device 145 from which the photo is received, the authentication engine 100 authenticates the user to access the service via the personal computer 140.

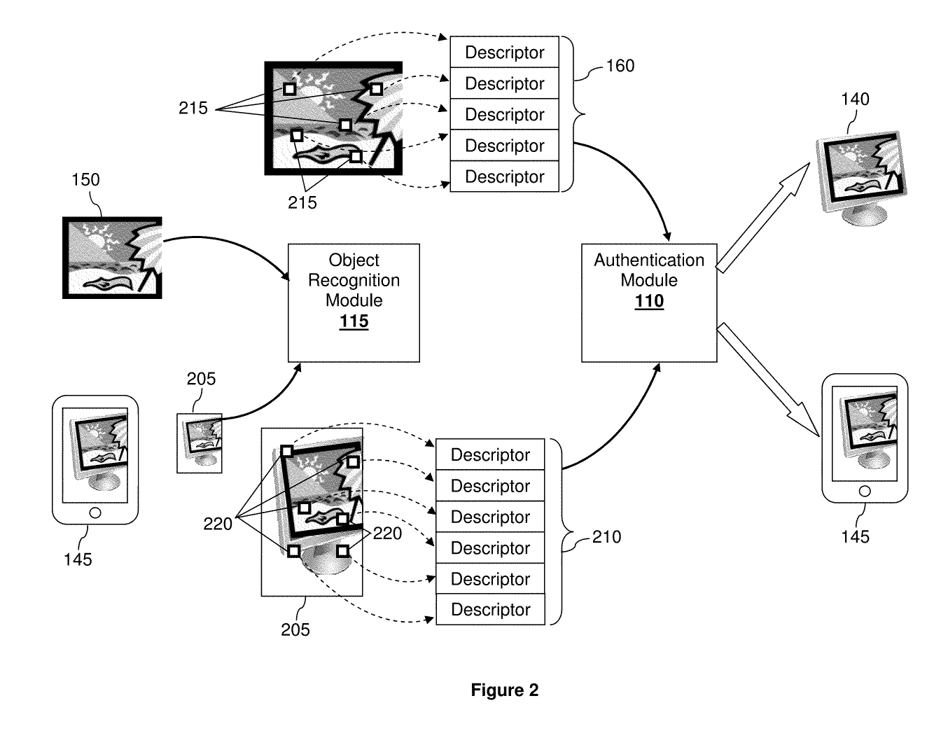

FIG. 2 illustrates the authentication process performed by the authentication engine 100 (specifically the object recognition module 115 and the authentication module 110) in more detail. Using the example described above, the user has provided the image 150 to the authentication engine 100 during the registration process as the image token for an online account. As part of the registration process, the object recognition module 115 is programmed to derive a descriptor set 160 for the image 150. To do so, the object recognition module 115 is programmed to first identify a set of features (e.g., local features, global features, a combination of both local and global features, etc.) on the digital representation (e.g., digital image data) of the image 150. In one example, the object recognition module 115 can use an image recognition algorithm such as scale-invariant feature transform (SIFT; see U.S. Pat. No. 6,711,293 titled “Method and apparatus for identifying scale invariant features in an image and use of same for locating an object in an image” filed Mar. 6, 2000) to detect and describe local features (as descriptors) in images.

The identified features can include an area of the digital representation around the edges and/or corners of a detected object within the digital representation. For example, an image of a soda bottle can have a descriptor that describes a part of the logo on the bottle, an edge of the bottle, a cap shape of the bottle, etc. In this example, the object recognition module 115 has identified five features 215 within the digital representation of the image token 150 to form the descriptor set 160. Preferably, the five features represent unique features of at least one object detected in the image token 150, but in any event, can uniquely identify the image token 150. For each identified feature, the object recognition module 115 is programmed to derive a descriptor (e.g., SIFT descriptors, Histogram of Gradients, etc.). The descriptor essentially characterizes one or more aspects (e.g., color aspect, gradient aspect, contrast aspect, etc.) of the corresponding identified feature.

Referring back to the example, upon receiving a request to access a service, the authentication engine 100 has presented an image token 150 associated with the user's service account on the computer 140, and instructed the user to capture a photo of the presented image token 150. In response, the authentication engine 100 has received, from the mobile phone 145, a photo 205 of the image token 150 being presented on the personal computer 140 and an identifier that uniquely identifies the mobile phone 145.

The authentication management module 105 sends the image token 150 to the object recognition module 115 to derive a set of image descriptors. The object recognition module 115 is programmed to use the same techniques as described above by reference to image 150 to derive a descriptor set for the photo 205. First, the object recognition module 115 identifies local or global features (such as features 220 as indicated by square boxes 220 on the image token 150 in FIG. 2) in the digital representation of the photo 205. Ideally, because the same object recognition module is executed to derive descriptors for both the image token 150 and the photo 205, similar features that have been identified on the image token 215 will be identified on the photo 205 by the object recognition module 115. The object recognition module 115 is programmed to then derive a descriptor for each of the identified local or global feature to generate a descriptor set 210. In view that object recognition module 115 has access to image 150, object recognition module 115 can clip image 205 as desired to focus on salient descriptors.

The descriptor set 160 of the image token 150, the descriptor set 210 of the captured photo 205, and the identifier of the mobile phone 145 are passed to the authentication module 110 by the authentication management module 105. The authentication module 110 is programmed to generate a difference between the descriptor sets 160 and 210, and to authenticate the user to use a service via the computing device 140 based on the generated difference and the identifier of the mobile phone 145.

It is contemplated that it is almost impossible for the captured photo 205 to be identical to the image token 150. The lighting condition of the environment, the angle at which the photo 205 is being captured with respect to the plane of the monitor presenting the image token 150, the quality of the camera used to capture the photo can all contribute to the differences between the original image token 150 and the photo 205 captured of the image token. Some of the issues with the photo 205 are caused by the camera equipment being used to capture the photo 205 (e.g., optical distortion from a focal length of the lens). In some embodiments, the authentication engine 100 performs a set of distortion elimination algorithms on the authentication image to eliminate some of the issues with the photo 205. However, some other issues cannot be eliminated by software (e.g., angle at which the photo was taken, etc.).

As shown in this example, the photo 205 illustrates some of the problems when the user captures the image token 150 as it is presented on the computer device 140. In this example, the photo 205 does not include the entire image token 150 (part of the image 150 is cut off on the right) while including objects beside the image token 150 (e.g., part of the device 140, part of the environment in which the device 140 is located, etc.). In addition, the photo 205 was captured not at a perpendicular angle with respect to the plane of the device 140 presenting the image 140. As such, the image token 150 looks slanted (the left side of the image appears to be smaller than the right side of the image).

Thus, one of the features of the contemplated inventive subject matter includes authenticating the user based on a difference between the descriptor sets 160 and 210. The advantage is that rather than requiring an identical match, the authentication engine 100 is programmed to authenticate the user to use the service even though there are differences between the descriptor sets 160 and 210. The differences can be generated by the authentication module 110 by comparing the descriptors in the set 160 against the descriptors in the set 210.

Different embodiments of the invention implements different techniques to generate the difference between the two descriptor sets 160 and 210. Under one approach, the authentication module 110 generates the difference by determining what percentage of the descriptors in the set 160 have a corresponding matching descriptors in the set 210. For a descriptor in the set 160 to match a descriptor in the set 210, the two descriptors need not be identical. Rather, the two descriptors can match as long as the descriptors overlap with each other by a certain threshold (e.g., 80%, 90%, etc.). The threshold for matching can be pre-determined and adjusted based on empirical data. Descriptors 210 can be compared to descriptors 160 through various techniques. For example, descriptors 160 can be arranged in a spill tree or kD tree data structure, which allows authentication module 110 to determine which of descriptors 210 are nearest neighbors to descriptors 160. Those resulting set of nearest neighbor pairs can be compared to each other to determine their relative distances (e.g., Euclidean distance, Hamming distance, Kernel-based distance calculation, etc.) from each other in the descriptor space. If a sufficient number of nearest neighbor pairs have desirable distances, perhaps less than a threshold distance, then authentication module 110 can proceed with authentication. It should be appreciated that object recognition module 115 could transform (e.g., clip, rotate, affine transform, etc.) image 205 to focus only on regions of interest

The authentication module 110 of some embodiments is programmed to authenticate the user to use the service when the generated difference is below a certain predetermined threshold (e.g., 20%, 10%, etc.) and the received identifier of the mobile phone 145 matches (e.g., being identical to) the identifier of the authentication device associated with the service account. The authentication module 110 is programmed to reject the user from using the service when the generated difference is above the certain predetermined threshold or when the received identifier of the mobile phone 145 does not match (e.g., not being identical to) the identifier of the authentication device associated with the service account. Again, the difference threshold for authentication can be pre-determined and adjusted based on empirical data. For example, if the predetermined threshold is 20%, the authentication module 110 must find descriptors in the set 210 that match at least four out of the five descriptors in the set 160 in order to authenticate the user. However, if the predetermined threshold is 10%, the authentication module 110 must find descriptors in the set 210 that match all five descriptors in the set 160 in order to authenticate the user. The image difference is presented as a single valued threshold for clarity of presentation. However, it should be appreciated that the image difference, especially with respect to descriptor representations, can be multi-valued. Thus, the “threshold” could comprise multi-value authentication criteria. Example of multi-valued differences can include descriptor values, number of detected descriptors, confidence scores in descriptors, relative distances between observed descriptors and known descriptors, or other factors.

When the authentication module 110 determines that the user is authenticated, the authentication module 110 is programmed to notify the service and/or the computing device 140 that the user is authenticated (e.g., sending an authentication notification to the service and/or the computing device via a network), and provide the user access to use access the service. Sending the authentication notification and enabling user access to the service marks the end of the authentication process (handshake session). In some embodiments, instead of notifying the service to provide access to the user via the computing device 140 immediately, the authentication engine 100 sends a one-time session specific pass code to the user via the authentication device 145 (e.g., causing the authentication device 145 to display the pass code), and cause the service to prompts the user for the one-time session specific pass code via the computing device 140. The user can then access the service by responding to the prompt and entering the pass code at the computing device 140.

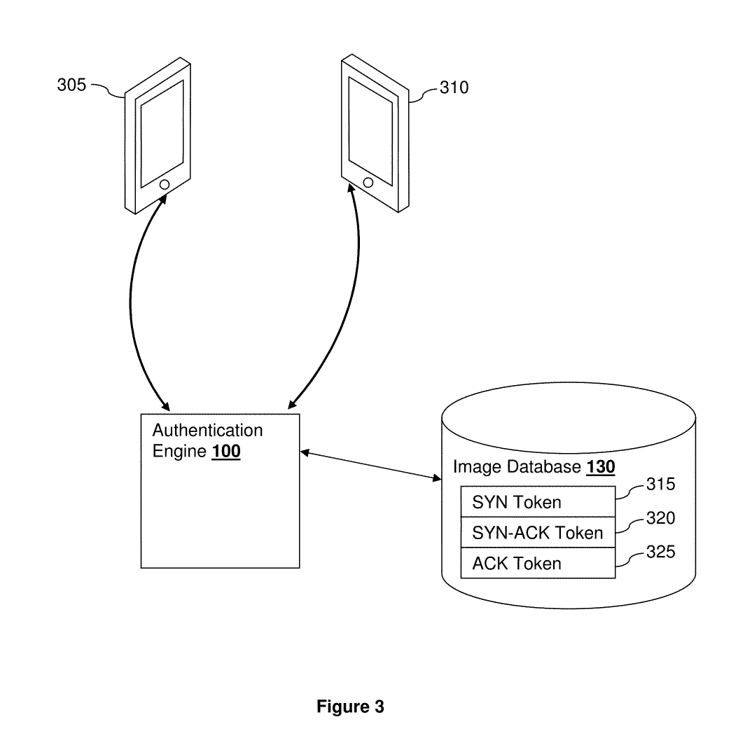

The above illustration describes using the inventive authentication technique to authenticate a user to access a service (e.g., online banking service, social media service, etc.). It has been contemplated that the same technique can be used to establish a communication channel between two devices (e.g., two mobile devices) by way of a protocol handshake, perhaps a TCP-like 3-way SYN, SYN-ACK, ACK handshake. In such embodiments, the authentication process (handshake session) comprises the 3-way handshake for example, although other types of protocol session initiations are also contemplated (e.g., port knocking, etc.). FIG. 3 illustrates an example environment 300 in which the 3-way handshake takes place among computing device 305, computing device 310, and authentication engine 100. The computing devices 305 and 310 can include a mobile device, a robot, a medical device, and other devices that have a camera and a display screen. As shown, the authentication engine 100 has access to the image database 130.

In some embodiments, the image database 130 stores three image tokens for the 3-way handshake between computing device 305 and computing device 310: a SYN image token 315, a SYN-ACK image token 320, and an ACK image token 325. The authentication engine 100 is programmed to use the same object recognition techniques as described above to derive descriptor sets for the corresponding image tokens and store the descriptor sets in the image database 130.

To initiate a communication session between the computing devices 305 and 310, the two computing devices 305 and 310 are placed such that each computing device can use its camera to capture an image of the display of the other computing device. One example configuration can be having their display/camera sides (assuming the devices have cameras on the same side as the displays) face each other. The authentication engine 100 instructs computing device 305 to present the SYN image token 315 on the display (by sending the image token 315 to device 305 and instructing the device 305 to render and present the token 315 on its display).

The authentication engine 100 then instructs the computing device 310 to automatically capture a digital photo of the SYN-token being presented on the device 305 and send the digital photo to the authentication engine 100. Alternatively, the authentication engine 100 can instruct the user of the computing device 310 (by presenting the instruction on the display of the device 310) to use the device 310 to manually capture a digital photo of the SYN-token being presented on the device 305 send the digital photo to the authentication engine 100.

The authentication engine 100 uses the object recognition techniques as described above to derive a descriptor set for the received photo, and generate an image difference by comparing the descriptor set of the received photo against the descriptor set of the SYN image token 315. Based on the image difference, the authentication engine 100 can determine whether the received photo comprises the SYN image token 315.

Once it is determined that the computing device 310 captures a photo of the SYN image token 315, the authentication engine 100 then instructs the second mobile device to display the SYN-ACK image token 320 on its display. Similarly, the authentication engine 100 instructs the computing device 305 to automatically capture a digital photo of the SYN-ACK token 320 being presented on the device 310 and send the digital photo to the authentication engine 100. Alternatively, the authentication engine 100 can instruct the user of the computing device 305 (by presenting the instruction on the display of the device 305) to use the device 305 to manually capture a digital photo of the SYN-ACK token 320 being presented on the device 310 send the digital photo to the authentication engine 100.

The authentication engine 100 uses the object recognition techniques as described above to derive a descriptor set for the received photo, and generate an image difference by comparing the descriptor set of the received photo against the descriptor set of the SYN-ACK image token 320. Based on the image difference, the authentication engine 100 can determine whether the received photo comprises the SYN-ACK image token 320.

Once it is determined that the computing device 305 captures a photo of the SYN-ACK image token 320, the authentication engine 100 instructs the computing device 305 to display the ACK image token 325 on the display. The authentication engine 100 then instructs the computing device 310 to automatically capture a digital photo of the ACK token 325 being presented on the device 305 and send the digital photo to the authentication engine 100. Alternatively, the authentication engine 100 can instruct the user of the computing device 310 (by presenting the instruction on the display of the device 310) to use the device 310 to manually capture a digital photo of the ACK token 325 being presented on the device 305 send the digital photo to the authentication engine 100.

The authentication engine 100 uses the object recognition techniques as described above to derive a descriptor set for the received photo, and generate an image difference by comparing the descriptor set of the received photo against the descriptor set of the ACK image token 325. Based on the image difference, the authentication engine 100 can determine whether the received photo comprises the ACK image token 325.

Once it is determined that the computing device 310 has captured a photo of the ACK image token 325, the authentication engine 100 notifies the two mobile devices that the 3-way handshake is complete and enables the two devices 305 and 310 to communication in a new communication session. In addition to the handshake information, the two devices 305 and 310 can use the image tokens to exchange encryption information for the communication session via the authentication engine.

The two computing devices can communicate during the session by presenting and varying the images presented on their respective displays. By capturing photos of images presented on the other device and sending the captured photos to the authentication engine 100, the authentication engine 100 helps to interpret the presented images and derive meaning out of the images for the two mobile devices based on the differences of presented images and observed images. Such an approach provides for visual, digital communication mechanism between or among devices without requiring a wired interface or traditional radio-based wireless interface. The advantage of such an approach is clear. The communication exchange between the two device is point-to-point without the data being exposed to external agents via wireless radio or through an intermediary network device (e.g., switch, router, etc.). This approach, for example, would allow a patient's device and healthcare provider's device to exchange data directly with each other in a broadband communication means without compromising the patient's data through leaked radio communications (e.g., WiFi, Bluetooth, etc.).

The disclosed inventive subject matter gives rise to various interesting capabilities. The image used for authentication does not necessarily have to completely identical to the original image. The authentication could transform the original image, possibly by reducing fidelity of the original image, to generate the authentication image. This approach allows the authentication engine to tune the authentication image to have a desired set of observable descriptors. The transformation could be autonomously generated by the authentication or could be determined through cooperation with the computer that will display the authentication. For example, the display computer can transmit its display capabilities to the authentication engine, which in turn uses the corresponding display parameters to determine what transform, if any, would be required to give rise to a desired authentication strength. Similarly the authentication engine could also communicate with the user's device to determine the properties of the user device's imaging sensor.

Interestingly, the disclosed techniques also give rise to machine-to-machine (M2M) communications as discussed above. Such techniques enable mobile robots (e.g., office robots, delivery robots, robotic healthcare providers, drones, etc.) to communicate with other computing devices. Consider a scenario where a patient has a robot assistant. Rather than the patient configuring the robot to communicate solely through wireless means, the patient could allow the robotic assistant to communicate with remote resources via a personal computer display. This approach ensures the robot has multiple communication channels should one fail and does not require complicated networking configuration steps that might be beyond the patient's capabilities or technical know-how.

In some other embodiments, the authentication engine can provide additional security measures for the authentication (or handshake) using the above-described technique. For example, the security measures can include geographical location boundary rules that prohibits authentication to occur unless the two devices are located within a boundary (e.g., within the premise of a bank, of a hospital, of a law firm, etc.). The boundary can be a location-based boundary that takes into account the longitude, latitude, and altitude coordinates. Since the communications after the authentication (or handshake) can involve transmission of sensitive information among devices (e.g., patient medical information, client confidential information, etc.), imposing the geographical boundary limitation forces the sharing of sensitive information to be limited to a certain premise and prevents eavesdropping of the communication from other devices. The authentication engine of some embodiments can be programmed to impose the geographical boundary rules based on the geographical locations of the devices that would like to start a communication session (e.g., the device via which the user would like to access a service and the authentication device, or the two devices that wish to initiate an M2M communication), such that one or both devices have to be within the boundary to have any sort of communication session. The geographical location of the devices can be detected using a GPS module of the devices, or using the Internet Protocol (IP) address of the devices.

In some embodiments, the authentication engine can also be programmed to impose the geographical boundary rules based on the geographical locations of the devices and also the authentication engine. In addition, the authentication engine can also be programmed to impose the geographical boundary limitation based on a type of communication (e.g., communication of patient information, communication of information related to a legal case, communication for social networking, etc.) desired by the devices. Accordingly, a user can define these geographical boundary rules for different devices and different types of communication via a user interface of the authentication engine.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of initiating a handshake between a first device and a second device, comprising:
instructing, by an authentication engine, the first device to present an image token to the second device, wherein the image token is associated with a first set of image descriptors previously derived from the image token;
receiving, at the authentication engine, image data from the second device, the image data being representative of a photo of the image token presented on the first device;
deriving, by the authentication engine, a second set of image descriptors from the image data;
generating, by the authentication engine, an image difference between the image token and the image data by comparing the first set of image descriptors and the second set of image descriptors; and
initiating, by the authentication engine, a handshake session between the first and second devices as a function of the generated difference.

2. The method of claim 1, wherein the handshake session allows a user to use a service via the first device.

3. The method of claim 1, wherein initiating the handshake session comprises establishing a communication channel between the first and second devices.

4. The method of claim 1, wherein the handshake session has a duration attribute.

5. The method of claim 1, wherein the handshake session has an access level attribute.

6. The method of claim 1, wherein initiating the handshake session comprises initiating the handshake session between the first and second devices when the generated image difference indicates that the first set of image descriptors and the second set of image descriptors are not identical.

7. The method of claim 6, wherein initiating the handshake session further comprises initiating the handshake session between the first and second devices only when the generated image difference is below a predetermined threshold.

8. The method of claim 1, wherein the first and second devices are communicatively coupled to the authentication engine, but are not communicatively coupled with each other.

9. The method of claim 1, further comprises aborting the handshake session when no image data is received from the second device within a predetermined duration of time.

10. The method of claim 1, further comprises aborting the handshake session between the first and second devices when the generated image difference exceeds a predetermined threshold.

11. The method of claim 1, wherein initiating the handshake session comprises providing a one-time session specific pass code to the second device.

12. The method of claim 1, further comprising providing an interface that enables a user to select an image as the image token for initiating the handshake session.

13. The method of claim 12, wherein the interface further enables the user to rotate the selected image and use the rotated image as the image token for initiating the handshake session.

14. A system for initiating a handshake between a first device and a second device, comprising:
an image database configured to store a plurality of image tokens and image descriptors associated with each of the plurality of image tokens; and
an authentication engine communicatively coupled to the image database and programmed to:
instruct the first device to present a first image token selected from the plurality of image tokens, wherein the first image token is associated with a first set of image descriptors,
receive image data from the second device, wherein the image data is representative of a photo of the image token presented on the first device,
derive a second set of image descriptors from the image data,
generate an image difference between the first image token and the image data by comparing the first set of image descriptors and the second set of image descriptors, and
initiate a handshake session between the first and second devices as a function of the generated difference.

15. The system of claim 14, wherein the authentication engine is further programmed to initiating the handshake session between the first and second devices when the generated image difference indicates that the image token and the image data is different.

16. The system of claim 15, wherein the authentication engine is further programmed initiate the handshake session further comprises initiating the handshake session between the first and second devices only when the generated image difference is below a predetermined threshold.

17. The system of claim 14, wherein the first and second devices are communicatively coupled to the authentication engine, but are not communicatively coupled with each other.

18. The system of claim 14, wherein the authentication engine is further programmed to abort the handshake session when no image data is received from the second device within a predetermined duration of time.

19. The system of claim 14, wherein the handshake session allows a user to use a service via the first device.

20. The system of claim 14, wherein the authentication engine is further programmed to initiate the handshake session by establishing a communication channel between the first and second devices.
